(19) United States
(12) Patent Application Publication
(10) Pub. No.: US 2010/0154162 A1
(43) Pub. Date: Jun. 24, 2010

(54) Antirotation system for metal bushings in carbon fiber fittings

(76) Inventors: Gonzalo Ramirez Blanco, Madrid (ES); Daniel Barroso Vloedgraven, Madrid (ES)

Correspondence Address: KLAUBER & JACKSON, 411 HACKENSACK AVENUE, HACKENSACK, NJ, 07601, US

(21) Appl. No.: 12/378,597

(22) Filed: Feb. 17, 2009

(30) Foreign Application Priority Data
Dec. 22, 2008 (ES) P200803647

(51) Int. Cl. F16C 33/04

(52) U.S. Cl. 16/2.1

(57) ABSTRACT

The invention concerns an antirotation system for metal bushings that are installed on carbon fiber fittings used in the design and construction of aeronautical structures, particularly those that include carbon fiber components. The system is essentially characterized in that it comprises a main piece (1) linked to the respective metal bushing, linkage that comprises means for avoiding relative rotation between the metal bushing (2) and the main piece (1), at the same time that the main piece comprises at least one bracket (5) embracing at least one side portion (6) of the fitting for its immobilization.

### OBJECT OF THE INVENTION

As stated in the title of this descriptive specification, the present invention relates to an antirotation system for metal bushings in carbon fiber fittings applicable in the field of aeronautical structures with the aim of blocking the bushings in order to prevent them from rotating and thus prevent wear and anomalies that could result in failures.

### BACKGROUND OF THE INVENTION

Given the properties of carbon fiber laminates, the traditional system used for the fixing of bushings to metal fittings is not applicable to new designs.

In metal fittings, the installation of bushings with interference has commonly been used as a method for preventing the possible rotation of the bushing in its housing. Another method used with a certain frequency is the installation of cotters for this same purpose.

However, the pressure that would be exerted by the installation of a bushing with interference on a fitting manufactured by means of carbon fiber laminate can rise to the delamination of the fiber layers, with the consequent degradation of the component and loss of properties rendering it unserviceable. Moreover, the machining of cotter holes on the fiber is much more complicated than on metal, and the reaction of the cotter on the fiber could also cause undesirable damage.

Therefore it becomes necessary to develop an alternative method, which would not entail assembly with interference nor the machining of cutter holes or notches in the fiber fitting, and which would adapt itself to the particular characteristics of composite materials, and especially carbon fiber laminates

### SUMMARY OF THE INVENTION

With the aim of achieving the objectives and preventing the drawbacks mentioned above, the invention proposes an antirotation system for metal bushings in carbon fiber fittings, characterized in that it comprises a main metal piece which, on one side has suitable housings which are coupled to the metal bushing it is sought to brake or restrict the rotation of in either direction, and on its opposite side has some brackets which clasp a lug of the fitting, generating the necessary reaction for impeding rotation of the unit.

The metal bushing basically comprises a tubular body housed in a complementary gap in the fitting, with one of the ends of that tubular body having an annular extension that runs up against one of the faces (front) of the fitting while the other end of said tubular body has a projecting exterior threaded section where a locking nut is coupled in order to axially ensure the fixing of the metal bushing. This nut is provided in correspondence with the opposite face (rear) of the fitting.

Accordingly, the antirotation metal piece is coupled to the bushing in correspondence with its annular extension, in such a way that the said metal piece has a central annular body that embraces the annular extension at the same time as having radial stubs fitting into complementary recesses of that extension of the tubular body of the metal bushing.

The brackets that project from the annular body of the central extension are in turn adapted by means of pertinent folds, embracing edge portions of the fitting in order to thereby ensure the immobilization of the bushing preventing it from rotating in either direction, though without affecting the fastening of the bushing by means of the axial securing nut provided in correspondence with the rear face of the fitting.

The advantages of the new system described by the invention are, among others, the following:

It does not require any holes to be drilled in the fitting where it is installed, thereby reducing the impact on it.

It avoids the assembly with interference of the metal bushing on the fitting.

It can be installed coupled to a crenellated shape of the annular extension of the tubular body of the bushing (or any other characteristic shape) which the fitting has for coupling of the tool used for the application of the tightening torque in its installation. Moreover, it does not interfere with nor hinder the installation of the locking nut that secures the bushing via the opposite face as it has been referred to earlier.

It can be manufactured in sheet metal, which will be able to be folded simply, this solution being easy and economical.

Below, in order to facilitate a better understanding of this descriptive specification and forming an integral part thereof, some figures are attached in which, by way of illustration and non-limiting, the object of the invention has been represented.

### BRIEF DESCRIPTION OF THE DRAWINGS

FIG. 1.—Represents an exploded perspective view of the antirotation system for metal bushings in carbon fiber fittings, the object of the invention. It essentially shows the constituent parts of the antirotation system applied to a metal bushing associated with a fitting linked to a horizontal stabilizer of an aeronautical structure.

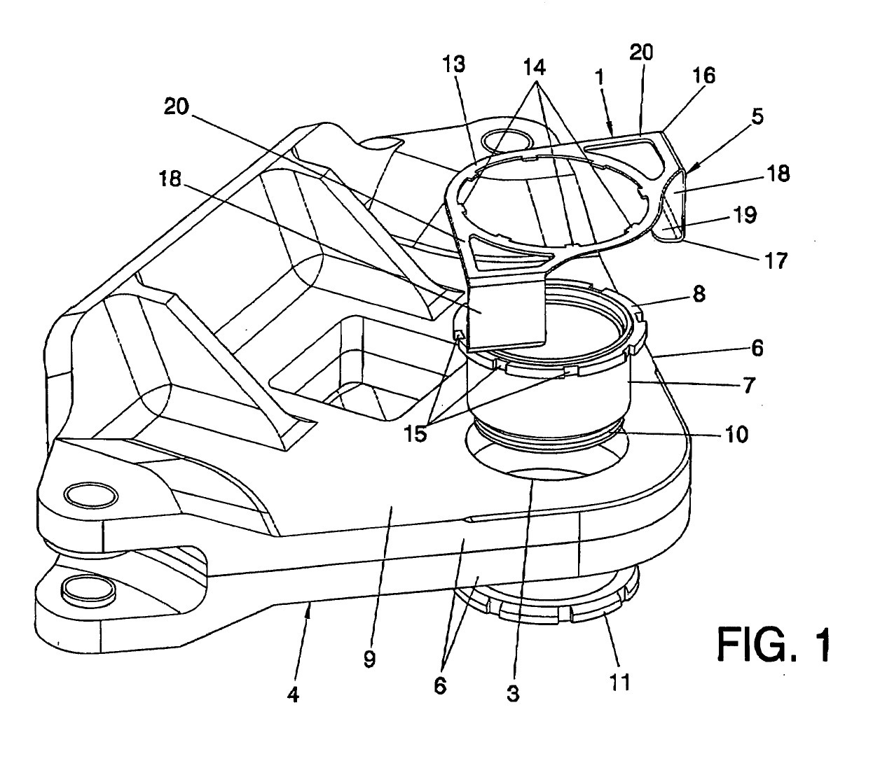

FIG. 2.—Represents a perspective view of the antirotation system fitted corresponding to that shown in the previous figure.

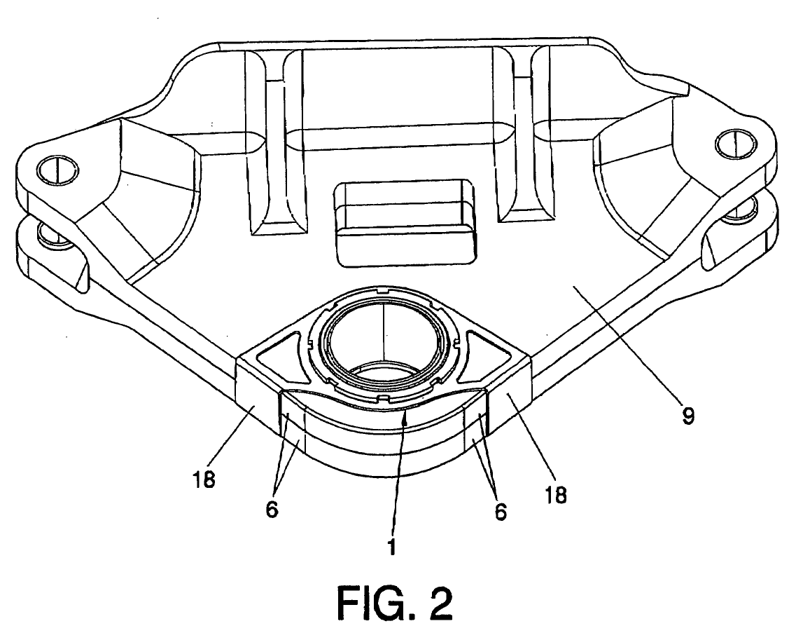

FIG. 3.—Shows a perspective view of the metal bushing that is immobilized to prevent its rotation with the antirotation system of the invention.

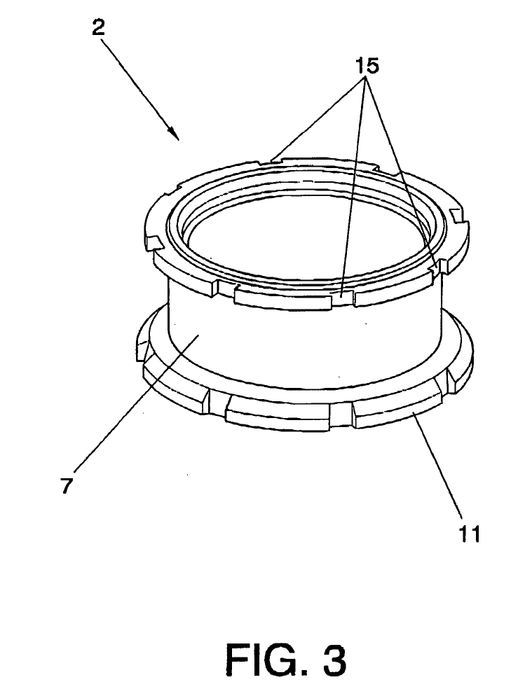

FIG. 4.—Shows a perspective view of a detail of the invention in correspondence with the rear face of the fitting.

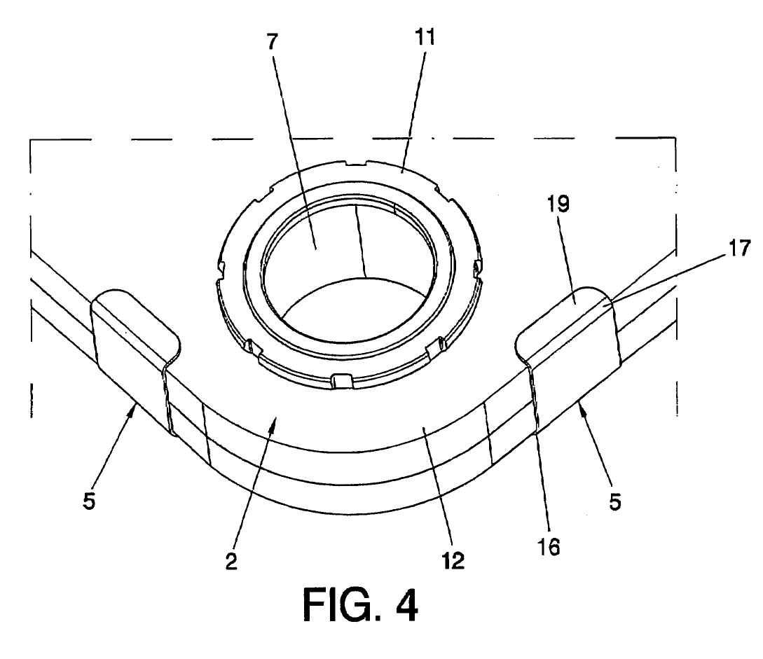

### DESCRIPTION OF THE PREFERRED FORM OF EMBODIMENT

Considering the numbering adopted in the figures, the antirotation system for metal bushings in carbon fiber fittings comprises a main metal piece 1 linked to part of a metal bushing 2 housed in a complementary gap 3 of the fitting 4, in such a way that this linkage has the purpose of in principle preventing the relative rotation between the bushing 2 and the said main piece 1.

This main piece 1 in turn has a pair of brackets 5 which embrace side portions 6 of the fitting 4 in order to thereby immobilize the actual main piece 1 in combination with the linkage of the main piece 1 to the metal bushing 2. In another embodiment, the main piece 1 could incorporate a single bracket 5 and be manufactured in different materials.

The linkage of the main piece 1 with the metal bushing 2 and in turn by means of the brackets 5 with the fitting 4 achieves the final objective of restricting the relative rotation between the fitting 4 and the metal bushing 2.

The said metal bushing 2 basically comprises a tubular body 7 fitted in a complementary gap 3 of the fitting 4, with one end of the tubular body 7 consisting of a crenellated annular extension 8 which axially runs up in the opposite direction against the front face 9 of the fitting 4 while the other end of the tubular body 7 of the metal bushing 2 has a projecting external threaded section 10 to which is coupled a locking nut 11, also crenellated, in order to axially secure the fixing of the bushing 2 in the other direction, said crenellated nut 11 being arranged in correspondence with the rear opposite face 12 of the fitting 4.

The antirotation main piece 1 comprises a central annular body 13 which fits around the crenellated extension 8 of the tubular body 7 of the metal bushing 2, this central annular body 13 comprising some radial stubs 14 which are introduced into complementary recesses 15 of the crenellated extension 8 of the metal bushing 2.

Moreover, the brackets 5 of the metal piece 1 consist of some extensions with two consecutive folds 16 and 17 in order to adapt to and embrace the side portions 6 of the fitting 4 and thereby ensure the immobilization of the actual metal piece 1 and also evidently the metal bushing 2 assembly, preventing its rotation in either direction.

The folds 16 and 17 of the brackets 5 of the main metal piece 1 give rise to a first sector 20 coplanar with the central annular body 13, a second intermediate sector 18 which is in contact with the actual side portions 6 of the fitting 4 and a third end sector 19 which is in contact with the rear face 12 of the fitting 4. In turn, the said folds 16 and 17 are arranged in correspondence with the edges where the side portions 6 of both faces 9 and 12 of the fitting 4 converge.

1. ANTIROTATION SYSTEM FOR METAL BUSHINGS IN CARBON FIBER FITTINGS, the metal bushings comprising a tubular body fitted in a complementary gap of the fitting and in which one end comprises an annular extension that stops against a front face of the fitting, and the tubular body of the metal bushing comprising means for axial retention via its opposite end arranged in correspondence with the rear face of the fitting, and wherein it has a main piece (1) linked to the annular extension (8), linkage comprising means for preventing relative rotation between the tubular body (7) of the metal bushing (2) and the main piece (1), at the same time as the latter has at least one bracket (5) which embraces at least one side portion (6) of the fitting (4) for its immobilization.

2. ANTIROTATION SYSTEM FOR METAL BUSHINGS IN CARBON FIBER FITTINGS according to claim 1, wherein the main piece (1) comprises an annular body (13), coupled around the annular extension (8) of the tubular body (7) of the metal bushing (2), said annular body (13) and annular extension (8) having male and female elements which complement each other in order to prevent relative rotation between the tubular body (7) of the metal bushing (2) and the main piece (1).

3. ANTIROTATION SYSTEM FOR METAL BUSHINGS IN CARBON FIBER FITTINGS according to claim 2, wherein the male elements comprise some radial stubs (14) integral with the annular body (13) of the main piece (1) while the female elements comprise recesses (15) made in the annular extension (8) of the tubular body (7) of the metal bushing (2).

4. ANTIROTATION SYSTEM FOR METAL BUSHINGS IN CARBON FIBER FITTINGS according to any of the above claims, wherein the brackets (5) of the main piece (1) comprise a first sector (20) coplanar with the central annular body (13) which is in contact with the front face (9) of the fitting (4), a second sector (18) which is in contact with the side portion (6) of the fitting (4) and a third end sector (19) which is in contact with the rear face (12) of the fitting (4).
